(19) United States
(12) Patent Application Publication
(10) Pub. No.: US 2014/0027021 A1
(43) Pub. Date: Jan. 30, 2014

(54) METHOD FOR MANUFACTURING CONDUCTIVE FILM ROLL

(71) Applicant: Nitto Denko Corporation, Osaka (JP)

(72) Inventors: Nozomi Fujino, Osaka (JP); Hiroyuki Takao, Osaka (JP); Kuniaki Ishibashi, Osaka (JP)

(21) Appl. No.: 13/946,271

(22) Filed: Jul. 19, 2013

(30) Foreign Application Priority Data
Jul. 24, 2012 (JP) 2012-163230

(51) Int. Cl. H01B 1/00

(52) U.S. Cl. CPC H01B 1/00
USPC 148/284

(57) ABSTRACT

A method for manufacturing a conductive film roll includes the following steps:
(a) preparing a first roll by rolling up a film substrate;
(b) laminating a first transparent conductor layer on a first surface of the film substrate while rewinding the film substrate from the first roll;
(c) forming a metal layer on the first transparent conductor layer;
(d) forming a metal oxide layer on a surface of the metal layer;
(e) forming a second transparent conductor layer on a second surface of the film substrate;
(f) forming a second metal layer on the second transparent conductor layer; and
(g) rolling up the film substrate where all film formation steps have been completed in the form of a roll, in which an entire process of the aforementioned steps is continuously performed in a film formation apparatus.

### BACKGROUND OF THE INVENTION

1. Field of the Invention

The present invention relates to a method for manufacturing a conductive film roll.

2. Description of Related Art

A conventional conductive film comprises: a film substrate; a plurality of transparent conductor layers; and a plurality of metal layers. The plurality of transparent conductor layers are formed on both surfaces of the film substrate. The plurality of metal layers are formed on respective transparent conductor layers (JP-A-2011-60146). Such a conductive film is used for a touch panel. The metal layers and the transparent conductor layers are etched to form wiring at an outer edge of a touch input region. This makes it possible to realize a touch panel with a narrow frame. However, there is a problem of blocking of adjacent metal layers in the conductive film when the conductive film is rolled up to obtain a conductive film roll. Blocking is to adhere metal layers to each other by pressure.

### SUMMARY OF THE INVENTION

It is an object of the present invention to realize a conductive film roll without blocking of adjacent metal layers thereof.

The summary of the present invention is described as below.

In a first preferred aspect, a method for manufacturing a conductive film roll according to the present invention includes the following steps of:
(a) preparing a first roll by rolling up a film substrate;
(b) laminating a first transparent conductor layer on a first surface of the film substrate after rewinding the film substrate from the first roll. The film substrate has two surfaces, in which a first surface is one surface of the film substrate. The first surface may be either of the two surfaces;
(c) laminating a first metal layer on the first transparent conductor layer;
(d) forming a metal oxide layer by oxidizing a surface of the first metal layer in oxygen atmosphere;
(e) laminating a second transparent conductor layer on a second surface of the film substrate, the second surface of the film substrate is the other surface of the film substrate;
(f) laminating a second metal layer on the second transparent conductor layer; and
(g) rolling up the film substrate in the form of a roll, in which the first transparent conductor layer, the first metal layer, and the metal oxide layer are laminated on the first surface and the second transparent conductor layer and the second metal layer are laminated on the second surface, an entire process of the aforementioned steps is continuously performed in a film formation apparatus.

In a second preferred aspect of the method according to the present invention, a material for the first metal layer and a material for the second metal layer are respectively copper, and a material for the metal oxide layer is copper oxide.

In a third preferred aspect of the method according to the present invention, a material for the first transparent conductor layer and a material for the second transparent conductor layer are respectively any one of indium tin oxide (ITO), indium zinc oxide or indium oxide-zinc composite oxide.

### ADVANTAGES OF THE INVENTION

The conductive film roll obtained by the manufacturing method of present invention has a metal oxide layer on the first surface of the film substrate. The metal oxide layer is not metallically bound to the second metal layer formed on the second surface of the film substrate due to no free electrons. Accordingly, there is no blocking between the metal oxide layer formed on the first surface of the film substrate and the second metal layer formed on the second surface of the film substrate. According to the present invention, the conductive film roll without blocking of the metal layers of the surfaces of the conductive film is realized.

When the conductive film is rolled up in the form of a roll, the metal oxide layer formed on the first surface of the film substrate is in contact with the second metal layer formed on the second surface of the film substrate. However, there is no blocking between the metal oxide layer and the second metal layer, so that it is not needed to insert a slip sheet when rolling up the conductive film in the form of a roll.

### BRIEF DESCRIPTION OF THE DRAWINGS

FIG. 1 is an explanatory drawing of a conductive film roll according to the present invention; and

FIG. 2 is a schematic view of a conductive film manufactured by a manufacturing method according to the present invention.

### DESCRIPTION OF THE PREFERRED EMBODIMENTS

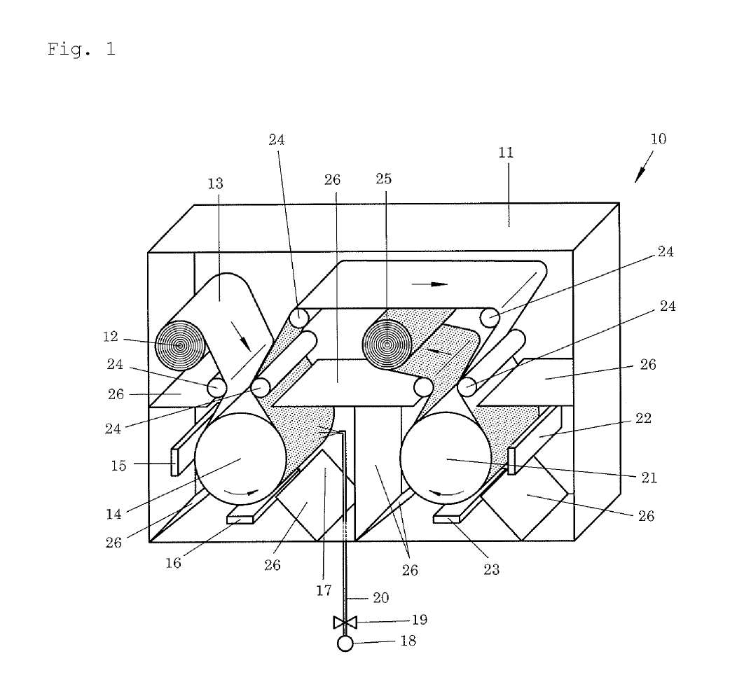

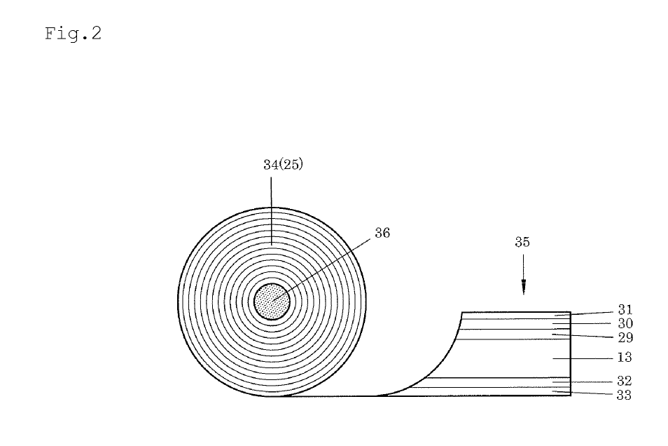

The preferred embodiments of the present invention will now be described with reference to FIGS. 1 to 2. Identical elements in the figure are designated with the same reference numerals.

In the case where the present invention is practiced by dividing a film formation step of a first surface and a film formation step of a second surface, a film substrate should be once rolled up in the form of a roll after the film formation of the first surface has been completed. At this time, there is a high possibility that dirt may be attached to the surface of the film substrate. In a manufacturing method of a conductive film roll of the present invention, the film substrate where the film formation step of the first surface has been completed is transported in a film formation apparatus to be continuously supplied to the film formation step of the second surface. In the manufacturing method of the present invention, there is, therefore, a lower possibility of dirt being mixed between respective laminated layers than that of the method of practicing the present invention by dividing the film formation step of the first surface and the film formation step of the second surface. Consequently, the conductive film roll manufactured by the manufacturing method of the present invention has few defects and is of good quality. Additionally, in the manufacturing method of the present invention, manufacturing efficiency is high due to no step of once rolling up the film substrate in the form of a roll between the film formation step of the first surface and the film formation step of the second surface.

### [Method for Manufacturing Conductive Film Roll]

A method for manufacturing a conductive film roll of the present invention is preferably practiced with a sputtering device 10 in FIG. 1. Parts and materials provided in the sputtering device 10 will now be described as below. A chamber 11 is used to maintain low-pressure gas atmosphere suitable for sputtering. The low-pressure gas atmosphere suitable for sputtering is an argon gas atmosphere of 0.1 Pa (Pascal) to 1 Pa.

A first layer forming roll 12 is obtained by rolling up a long film substrate 13. The film substrate 13 is a start material in a manufacturing process and is a base of a film to be formed hereafter. After being rewound from the first roll 12, the film substrate 13 passes through each film formation step described below and is then wound around a second roll 25. Since each film formation step is all performed in the sputtering device 10, there is no possibility that the film substrate 13 and laminated layers may be exposed to the outside air in the middle. Accordingly, there is a low possibility that dirt may be attached to the film substrate 13 and each laminated layer.

The first layer forming roll 14 rotates while winding the film substrate 13 around a surface thereof to move the film substrate 13. The first layer forming roll 14 is used to continuously form a first transparent conductor layer 29 (FIG. 2) and a first metal layer 30 (FIG. 2) on a first surface of the firm substrate 13. It is possible to control the temperatures of the surface of the first layer forming roll 14. The control range for the surface temperature of the first forming roll 14 is typically 20° C. to 250° C. The temperature of the film substrate 13 at the time of film formation is vertically the same as the surface temperature of the first layer forming roll 14 at the time of film formation.

A first target material 15 is a material for the first transparent conductor layer 29 (FIG. 2). The first target material 15 is opposed to one portion of the surface of the first layer forming roll 14. The first target material 15 is electrically coupled to a direct-current power supply not shown which is outside the chamber 11. A sintering body target containing indium oxide and tin oxide is typically used as a first target material 15. In this case, the first transparent conductor layer 29 (FIG. 2) is an ITO (indium tin oxide) layer.

A second target material 16 is a material for a first metal layer 30 (FIG. 2). The second target material 16 is opposed to a portion of the surface of the first layer forming roll 14. The second target material 16 is electrically coupled to a direct-current power supply not shown which is outside the chamber 11. The second target material 16 is preferably any one of copper, silver, aluminum, nickel alloy, copper alloy, titanium alloy or silver alloy and is more preferably copper. When the second target material 16 is copper, the first metal layer (FIG. 2) is a copper layer.

A portion of the chamber 11 is divided to obtain an oxygen atmosphere chamber 17. Oxygen gas passes from an oxygen valve 18 through a pressure control valve 19 and then passes through the oxygen gas introducing tube 20 to be supplied to the oxygen atmosphere chamber 17. Oxygen gas in the oxygen atmosphere chamber 17 typically has a pressure of 0.0005 Pa to 1 Pa. Gas exists in the oxygen atmosphere chamber 17 is substantially oxygen gas alone. A surface of the first metal layer 30 (FIG. 2) formed on the first surface of the film substrate 13 is oxidized by oxygen gas to form a metal oxide layer 31 (FIG. 2).

The second layer forming roll 21 rotates while winding the film substrate 13 around a surface of the second layer forming roll 21 to move the film substrate 13. The second layer forming roll 21 is used to continuously form a second transparent conductor layer 32 (FIG. 2) and a second metal layer 33 (FIG. 2) on a second surface of the firm substrate 13. It is possible to control the temperatures of the surface of the second layer forming roll 21. The control range for the surface temperature of the second layer forming roll 21 is typically 20° C. to 250° C. The temperature of the film substrate 13 at the time of film formation is substantially the same as the surface temperature of the second layer forming roll 21.

A third target material 22 is a material for the second transparent conductor layer 32 (FIG. 2). The third target material 22 is opposed to a portion of the surface of the second layer forming roll 21. The third target material 22 is electrically coupled to a direct-current power supply not shown which is outside the chamber 11. A sintering body target containing indium oxide and tin oxide is typically used as the third target material 22. In this case, the second transparent conductor layer 32 (FIG. 2) is an ITO (indium tin oxide) layer.

A fourth target material 23 is a material for a second metal layer 33 (FIG. 2). The fourth target material 23 is opposed to a portion of the surface of the second layer forming roll 21. The fourth target material 23 is electrically coupled to a direct-current power supply not shown which is outside the chamber 11. The fourth target material 23 is preferably any one of copper, silver, aluminum, nickel alloy, copper alloy, titanium alloy or silver alloy and is more preferably copper. When the fourth target material 23 is copper, the second metal layer (FIG. 2) is a copper layer.

Respective sputtering regions of the first target material 15, the second target material 16, the third target material 22, and the fourth target material 23 and the region of the oxygen atmosphere chamber 17 are divided by respective dividing plates 26 and are, therefore, independent each other. As a result, sputter gas (for example, argon gas) and oxygen gas are trapped in respective regions. Accordingly, there is no possibility of oxygen gas entering the region of the adjacent sputter regions. Further, there is no possibility of sputter gas entering the region of the oxygen atmosphere chamber 17.

The film substrate 13 is conveyed in the chamber 11 by a plurality of guide rolls 24 arranged in a suitable position. The second roll 25 is obtained by rolling up the film substrate 13 (i.e., a conductive film 35) in the form of a roll where all film formation has been completed. Next, the manufacturing method of the present invention will now be described in the order of steps.

First, the first transparent conductor layer 29 (FIG. 2) is formed on the first surface of the film substrate 13. The long film substrate 13 is conveyed in the chamber 11 while rewinding the long film substrate 13 from the first roll 12 to wind around the first layer forming roll 14. The first layer forming roll 14 is rotated to continuously move the film substrate 13 to the film formation position of the first transparent conductor layer 29 (FIG. 2). When the first transparent conductor layer 29 (FIG. 2) is formed by sputtering, argon plasma is generated by the application of a direct-current voltage between the first layer forming roll 14 and the first target material 15. Typically, the electric potential of the first layer forming roll 14 is 0V and the electric potential of the first target material 15 is −400V to −100V. Argon ion is caused to collide with the first target material 15 to attach a material for the first transparent conductor layer 29 (FIG. 2) scattered from the first target material 15 to the first surface of the film substrate 13. In such a manner, the first transparent conductor layer 29 (FIG. 2) is formed on the first surface of the film substrate 13.

The first metal layer 30 (FIG. 2) is subsequently formed on the first transparent conductor layer 29 (FIG. 2). The film substrate 13 where the formation of the first transparent conductor layer 29 has been completed is caused to continuously move to the film formation position of the first metal layer 30. When the first metal layer 30 is formed by sputtering, argon plasma is generated by the application of a direct-current voltage between the first layer forming roll 14 and the second target material 16. Typically, the electric potential of the first layer forming roll 14 is 0V and the electric potential of the second target material 16 is −400V to −100V. Argon ion is caused to collide with the second target material 16 to attach the material for the first metal layer 30 (FIG. 2) scattered from the second target material 16 to the surface of the first transparent conductor layer 29 formed on the film substrate 13. In such a manner, the first metal layer (FIG. 2) on the film substrate 13 is formed on a surface of the first transparent conductor layer 29 (FIG. 2).

Subsequently, a surface of the metal layer 30 (FIG. 2) is oxidized to obtain a metal oxide layer 31 (FIG. 2). Oxygen gas is supplied to the oxygen atmosphere chamber 17. Oxygen gas preferably has a pressure of 0.0005 Pa to 1 Pa, more preferably 0.0005 Pa to 0.1 Pa. Gas which exists in the oxygen atmosphere chamber 17 is substantially oxygen gas alone. The film substrate 13 on which the first metal layer 30 (FIG. 2) has been formed is caused to continuously move to the oxygen atmosphere chamber 17. A surface of the first metal layer 30 (FIG. 2) is oxidized by oxygen atmosphere to form a metal oxide layer 31 (FIG. 2).

Subsequently, a second transparent conductor layer 32 (FIG. 2) is formed on a second surface of the film substrate 13. The film substrate 13 on which the metal oxide layer 31 (FIG. 2) has been formed is conveyed in the sputtering device 10 to be conveyed to the film formation step of the second transparent conductor layer 32 (FIG. 2).

The second layer forming roll 21 is wound around the second layer forming roll 21 with the second surface of the film substrate 13 facing outward. The second layer forming roll 21 is rotated to continuously move the film substrate 13 to the film formation position of the second transparent conductor layer 32 (FIG. 2). When the second transparent conductor layer 32 (FIG. 2) is formed by sputtering, argon plasma is generated by the application of a direct-current voltage between the second layer forming roll 21 and the third target material 22. Typically, the electric potential of the second layer forming roll 21 is 0V and the electric potential of the third target material 22 is −400V to −100V. Argon ion is caused to collide with the third target material 22 to attach a material for the second transparent conductor layer 32 (FIG. 2) scattered from the third target material 22 to the second surface of the film substrate 13. In such a manner, the second transparent conductor layer 32 (FIG. 2) is formed on the second surface of the film substrate 13.

Subsequently, the second metal layer 33 (FIG. 2) is formed on the second transparent conductor layer 32 (FIG. 2). The second layer forming roll 21 is rotated to move the film substrate 13 to the film formation position of the second metal layer 33 (FIG. 2). When the second metal layer 33 is formed by sputtering, argon plasma is generated by the application of a direct-current voltage between the second layer forming roll 21 and the fourth target material 23. Typically, the electric potential of the second layer forming roll 21 is 0V and the electric potential of the fourth target material 23 is −400V to −100V. Argon ion is caused to collide with the fourth target material 23 to attach a material for the second metal layer 33 (FIG. 2) scattered from the fourth target material 23 to a surface of the second transparent conductor layer 32 (FIG. 2). In such a manner, the second metal layer 33 (FIG. 2) is formed on the surface of the second transparent conductor layer 32 (FIG. 2).

The film substrate 13 (conductive film 35 (FIG. 2)) where each film formation has been completed on the first and second surfaces thereof is rolled up in the form of a roll to obtain a second roll 25. The second roll 25 is a finished product of a conductive film roll 34 (FIG. 2).

After forming the second metal layer 33 (FIG. 2), it is also possible to obtain a second metal oxide layer (not shown) by oxidizing a surface of the second metal layer 33 (FIG. 2).

### [Conductive Film Roll]

The conductive film 35 obtained by the manufacturing method of the present invention has the following constitution shown in FIG. 2:
(a) a film substrate 13;
(b) a first transparent conductor layer 29 laminated on a first surface of the film substrate 13;
(c) a first metal layer 30 laminated on the first transparent conductor layer 29;
(d) a metal oxide layer 31 formed on a surface of the first metal layer 30;
(e) a second transparent conductor layer 32 laminated on a second surface of the film substrate 13; and
(f) a second metal layer 33 laminated on the second transparent conductor layer 32.

The conductive film roll 34 is obtained by rolling up a long conductive film 35 in the form of a roll. The conductive film 35 typically has a length of 100 m or greater, preferably 500 m to 5,000 m. A roll core 36 made of plastic or metal is arranged in the central portion of the conductive film roll 34 because the conductive film 35 is generally wound around the central portion of the conductive film roll 34.

### [Film Substrate]

The film substrate 13 typically has a thickness of 20 μm to 200 μm. A material for the film substrate 13 is preferably a material with superior transparency and heat resistance. The material for the film substrate 13 is preferably polyethylene terephthalate, polycycloolefin or polycarbobnate.

The film substrate 13 may have an easily adhering layer (not shown) on a first surface thereof to increase adhesion of the film substrate 13 and the first transparent conductor layer 29. Moreover, the film substrate 13 may have an easily adhering layer (not shown) on a second surface thereof to increase adhesion of the film substrate 13 and the second transparent conductor layer 32.

The film substrate 13 may have an index-matching layer (not shown) on a first surface thereof to adjust reflectivity of the film substrate 13. Furthermore, the film substrate 13 may have an index-matching layer (not shown) on a second surface thereof to adjust reflectivity of the film substrate 13.

The film substrate 13 may have a hard coating layer (not shown) on a first surface thereof to prevent the first surface of the film substrate 13 from being scratched. In addition, the film substrate 13 may have a hard coating layer (not shown) on a second surface thereof to prevent the second surface of the film substrate 13 from being scratched.

### [Transparent Conductor Layer]

The first transparent conductor layer 29 preferably has a high transmittance in a visible light region (400 nm to 700 nm) and has a low surface resistance value per unit area. The transmittance of the first transparent conductor layer 29 in the visible light region is typically 80% or higher. The surface resistance value per unit area is typically 500Ω per square or lower. A material for forming the first transparent conductor layer 29 is preferably made of any one of indium tin oxide (ITO), indium zinc-oxide or indium oxide-zinc oxide composite oxide. The first transparent conductor layer 29 preferably has a thickness of 20 nm to 80 nm. The transmittance, the surface resistance value, the material, and the thickness of the second transparent conductor layer 32 are the same as those of the first transparent conductor layer 29.

### [Metal Layer]

The first metal layer 30 is formed on a surface of the first transparent conductor layer 29. A material for the first metal layer 30 is preferably copper, silver, nickel alloy, copper alloy, titanium alloy or silver alloy, more preferably copper. The first metal layer 30 preferably has a surface resistance value per unit area of 10Ω per square or lower, more preferably 0.1Ω per square to 1Ω per square. The first metal layer 30 preferably has a thickness of 20 nm to 300 nm. In the case where the first metal layer 30 has a thickness of less than 20 nm, there are fears that the first metal layer 30 may not be a perfect film. And even though a perfect film of the first metal layer 30 is obtained, there are fears that electric resistance may become excessively high. In the case where the thickness of the first metal layer 30 is over 300 nm, there are fears that workability of wirings may be lowered and the formation of fine patterns may become difficult. The material, the surface resistance value, and the thickness of the second metal layer 33 are the same as those of the first metal layer 30.

### [Metal Oxide Layer]

The metal oxide layer 31 is formed by oxidizing a surface of the first metal layer 30. The metal oxide layer 31 is preferably an oxide of cooper oxide, silver oxide, aluminum oxide, or an oxide of nickel alloy, an oxide of copper alloy, an oxide of titanium alloy, and an oxide of silver alloy, more preferably copper oxide. The metal oxide layer 31 preferably has a thickness of 1 nm to 15 nm. In the case where the thickness of the metal oxide layer 31 is less than 1 nm, there are fears that the metal oxide layer 31 could not perfectly cover the surface of the first metal layer 30. In this case, there are fears that sufficient blocking-prevention effects may be not obtained. In the case where the thickness of the metal oxide layer 31 is over 15 nm, there are fears that productivity may be lowered due to longer time for oxidizing the first metal layer 30.

The conductive film 35 to be used in the present invention may further have a second metal oxide layer (not shown) on a surface of the second metal layer 33. The second metal oxide layer is obtained by oxidizing a surface of the second metal layer 33. The suitable material and the thickness of the second metal oxide layer are the same as those of the metal oxide layer 31.

### EXAMPLES

### Example

A first roll 12 obtained by rolling up a film substrate 13 was set in a sputtering device 10 in FIG. 1. The film substrate 13 is a polycycloolefin film with a thickness of 100 μm and a length of 1,000 m (“ZEONER” (trademark) produced by ZEON CORPORATION). The atmosphere of a chamber 11 of the sputtering device 10 was turned into an argon gas atmosphere with a pressure of 0.4 Pa. Sintering body target materials containing indium oxide and tin oxide were used as a first target material 15 and a third target material 22. Oxygen-free copper target materials were used as a second target material 16 and a fourth target material 23.

The film substrate 13 was wound around a first layer forming roll 14 with a first surface facing outward while rewinding the first roll 12. The first layer forming roll 14 was rotated to continuously move the film substrate 13. A first transparent conductor layer 29 and a first metal layer 30 were continuously formed on the first surface of the film substrate 13. The first transparent conductor layer 29 was an indium tin oxide (ITO) layer having a thickness of 20 nm. The first metal layer 30 was a copper layer having a thickness of 50 nm.

Oxygen gas was supplied from an oxygen gas introducing tube to an oxygen atmosphere chamber 17 to set an oxygen gas pressure of the oxygen atmosphere chamber 17 at 0.001 Pa. A surface of the metal layer 30 (copper layer) was oxidized by the oxygen atmosphere to form a metal oxide layer 31 (copper oxide layer, thickness: 2 nm).

The film substrate 13 where the film formation had been completed on a first surface thereof was conveyed in the sputtering device 10 to be supplied to a second layer forming roll 21. The film substrate 13 was wound around the second layer forming roll 21 with the second surface thereof facing outward. The second layer forming roll 21 was rotated to continuously move the film substrate 13. A second transparent conductor layer 32 and a second metal layer 33 were continuously formed on the second surface of the film substrate 13. The second transparent conductor layer 32 was an indium oxide layer (ITO layer) with a thickness of 20 nm. The second metal layer 33 was a copper layer with a thickness of 50 nm. In this way, the film substrate 13 (conductive film 35) where all film formation had been completed was obtained.

A conductive film roll 34 was produced by winding the film substrate 13 (conductive film 35), where all film formation had been completed, around a roll core 36 made of plastic in the form of a roll.

(Blocking test) The conductive film roll 34 in Example was rewound and a surface of the conductive film 35 was observed. In the conductive film roll 34 in Example, no peeling noise in the blocking portion was produced in a blocking portion at the time of rewinding. Further, no scars were found on the surface of the rewound conductive film 35 at the time of peeling of the blocking portion. Accordingly, it is presumed that no blocking occurred in the conductive film roll 34 in Example.

### Comparative Example

A conductive film roll was produced in the same manner as in Example except that a step of oxidizing a surface of a first metal layer 30 was not performed (More specifically, oxygen gas was not supplied to the oxygen atmosphere chamber 17). In the conductive film roll in Comparative Example, peeling noise for destroying blocking was produced at the time of rewinding. In addition, a large number of scratches caused by blocking were observed on the surface of the conductive film. Accordingly, it is presumed that blocking occurred in the conductive film roll in Comparative Example.

### [Measuring Method]

### [Thickness of Metal Oxide Layer]

The thickness of the metal oxide layer was measured using an X-ray Photoelectron Spectroscopy Analyzer (Product name: Quantera SXM produced by ULVAC-PHI INCORPORATED).

### [Thickness of Transparent Conductor Layer, Metal Layer, and Film Substrate]

The thickness of the transparent conductor layer and the thickness of the metal layer were measured by performing a cross-sectional observation using a transmittance-type electron microscope (produced by Hitachi Ltd., product name: “H-7650”). The thickness of the film substrate was measured using a film meter (produced by Peacock Co., Ltd., product name: Digital Dial Gauge “DG-205”).

### [Blocking of Conductive Film Roll]

The conductive film 35 was rewound from the conductive film roll 34 and the surface of the conductive film 35 was observed to confirm whether or not there is blocking. In the case where blocking occurs, peeling noise is produced at the time when rewinding and a large number of scratches caused by blocking were generated on the surface of the conductive film 35.

### INDUSTRIAL APPLICABILITY

Although the application of the conductive film 35 obtained by the method for manufacturing a conductive film roll of the present invention is not limited. The conductive film 35 obtained by the manufacturing method of the present invention is cut into a size of a display panel and can be preferably used in a touch panel, more specifically, a capacitance-type touch panel.

This application claims priority from Japanese Patent Application No. 2012-163230, which is incorporated herein by reference.

There has thus been shown and described a novel method for manufacturing a conductive film roll which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A method for manufacturing a conductive film roll, comprising the steps of:
preparing a first roll by rolling up a film substrate;
laminating a first transparent conductor layer on a first surface of the film substrate after rewinding the film substrate from the first roll;
laminating a first metal layer on the first transparent conductor layer;
forming a metal oxide layer by oxidizing a surface of the first metal layer in oxygen atmosphere;
laminating a second transparent conductor layer on a second surface of the film substrate;
laminating a second metal layer on the second transparent conductor layer; and
rolling up the film substrate in the form of a roll, wherein the first transparent conductor layer, the first metal layer, and the metal oxide layer, the second transparent conductor layer, and the second metal layer are laminated,
an entire process of the aforementioned steps is continuously performed in a film formation apparatus.

2. The method according to claim 1, wherein a material for the first metal layer and a material for the second metal layer are respectively copper, and a material for the metal oxide layer is copper oxide.

3. The method according to claim 1 or claim 2, wherein a material for the first transparent conductor layer and a material for the second transparent conductor layer are respectively any one of indium tin oxide (ITO), indium zinc oxide or indium oxide-zinc composite oxide.
